(19) United States
(12) Patent Application Publication
(10) Pub. No.: US 2006/0027186 A1
(43) Pub. Date: Feb. 9, 2006

(54) Adaptive response protocol for a wireless fencing system

(76) Inventor: Salvatore John Giunta, Stroudsburg, PA (US)

Correspondence Address: DEMONT & BREYER, LLC, SUITE 250, 100 COMMONS WAY, HOLMDEL, NJ, 07733, US

(21) Appl. No.: 11/198,793

(22) Filed: Aug. 5, 2005

Related U.S. Application Data
(60) Provisional application No. 60/599,104, filed on Aug. 5, 2004.

(51) Int. Cl. A01K 15/04

(52) U.S. Cl. 119/721

(57) ABSTRACT

An “adaptive” response protocol for use with a pet containment system is disclosed. The adaptive response protocol is used to prevent breach of a containment or exclusion perimeter. The adaptive response protocol is based on certain habitual actions of a monitored animal. Since the adaptive response protocol takes the behavior of a monitored animal into account, it is a more accurate predictor of impending perimeter breach than a simple consideration of the animal's proximity to the perimeter.

### STATEMENT OF RELATED CASES

This application claims the benefit of U.S. provisional application Ser. No. 60/599,104, filed Aug. 5, 2004.

### FIELD OF THE INVENTION

The present invention relates to fencing systems that do not use a physical boundary for containment or exclusion.

### BACKGROUND OF THE INVENTION

Fencing systems that use a virtual barrier, rather than a physical barrier, to restrict the location and movement of animals are known in the art. There are two basic types of “virtual” fencing systems.

One type of virtual fencing system employs a buried wire that defines a containment perimeter. The wire radiates a signal that can be sensed by a device worn by a monitored animal. As the monitored animal approaches the perimeter, the signal is sensed and the device delivers a correction (e.g., typically sound or an electric shock) to the animal to dissuade it from breaching the perimeter.

The other type of virtual fencing system uses a wireless positioning system, such as GPS, to establish a perimeter and determine an animal's location. An example of such a “wireless” fencing system is disclosed in U.S. Pat. No. 6,581,546 (“the '546 patent”).

According to the '546 patent, a control unit that includes a GPS positioning receiver, a means for applying a correction, and suitable control and logic circuitry/software is attached to an animal's collar. In conjunction with the control unit, a user establishes a containment perimeter. The perimeter is defined by positional coordinates, which are obtained from the GPS positioning receiver. In use (after the perimeter is defined), the control unit compares the position of the receiver (i.e., the position of a monitored animal) with the containment perimeter. As the animal approaches the perimeter, as determined by the comparison, a correction is applied. If the animal breaches the perimeter, the control unit expands the perimeter in a further attempt at containment. The system attempts to redirect the movement of the animal toward the original containment zone using additional corrections as necessary. Further perimeter breaches are addressed by continued perimeter expansion. If the animal changes direction toward the original containment zone, the expanded perimeter is then contracted behind the animal.

### SUMMARY

The present invention provides an “adaptive” response protocol, rather than a fixed, predetermined set of rules (e.g., proximity to a containment perimeter, etc.) to prevent breach of a containment or exclusion perimeter (hereinafter simply “containment” perimeter). The adaptive response protocol disclosed herein is based on certain habitual actions of a monitored animal. Since this protocol takes the behavior of a monitored animal into account, it is a more accurate predictor of impending perimeter breach than a simple consideration of the animal's proximity to the perimeter. This adaptive response protocol can be used in conjunction with the systems and methods described in U.S. patent application Ser. Nos. 10/910,858, 10/910,863, and 10/870,397, which are all incorporated by reference herein in their entirety.

For some predetermined period after the time of first programming and use, a collar unit, which is worn by a monitored animal, will operate on a predefined set of rules. However, the collar unit will keep track of behavioral activity “learning” any repetitive behaviors of the monitored animal and charting periods of activity. This learning function will be adaptive, relying on patterns detected over a recent history of activity so as to respond to long term behavioral changes as the animal learns and ages or a new animal is introduced. These behaviors might indicate an impending attempt to breach the containment perimeter or be a habitual pattern of activity that would demand close monitoring due its magnitude and direction but which consistently avoids approaching the perimeter.

In consideration of factors such as power conservation, variations in behavior of different animals and effective charging response, the adaptive protocol described herein will have significant advantages over a fixed rule based design.

### DETAILED DESCRIPTION

A variety of habitual behaviors are tracked (i.e., stored in a database) and evaluated (e.g., by suitable software algorithms) to establish an adaptive response protocol in accordance with the illustrative embodiment of the present invention. The adaptive response protocol directs the system to take certain actions, such as issue a warning (e.g., sound, etc.), issue a correction (e.g., mild shock, etc.), continue to monitor the animal, or ignore the behavior based on the monitored animal's current behavior, current whereabouts, and, in some cases, the time of day.

### Habitual Behavior—Fence Running

Many animals develop the habit of fence running wherein they race back and forth on their side of the fence in response to some outside stimulus (e.g., another animal, etc.) or simply due to boredom. This would result in a very high update rate for the GPS circuitry, based on a fixed rule set, resulting in significant and excessive power consumption. If this were a typical behavior for this particular animal, and the animal did not historically challenge the containment perimeter, then it is advantageous not to continue to call the GPS circuitry after an initial fix, or set of fixes, have been taken. An accelerometer included in the collar unit is sufficient to confirm this previously identified and non-critical behavior.

### Habitual Behavior—Work up to Charge

Because there is a warning and correction associated with crossing the boundary, some dogs will need to get “worked up” prior to charging the boundary. They might use fence running, as described above, or they might run back and forth across the yard or run in a circle. What is significant is the detection of a typical behavior associated with a subsequent action. If it appears that a particular behavior is a prelude to a boundary crossing attempt, then the system responds in a pre-emptive manner with at least a warning.

### Habitual Behavior—Favorite Locations

Dogs tend to establish habitual resting and activity locations. These locations often vary seasonally. For example, a winter rest location will often be in direct sunlight whereas a summer location is more likely to be under some form of cover such as a porch, a deck or tree.

Once a habitually-occupied location is “known” to the system, and even if the GPS is unable to establish a fix on a monitored animal, the system will be able to operate effectively. If there is little or no accelerometer output then the animal is stationary or moving slowly. If there is a large acceleration component then the system would look at historical data to determine likely future activity and respond accordingly.

In some embodiments, the adaptive response protocol will take into account the relationship between a habitual location and a monitored animal's proximity to the nearest containment perimeter. If the habituation point is far from the perimeter, then a run-through would require a significantly greater period of time to accomplish than if the perimeter were close.

### Habitual Behavior—Activity Periods

Dogs tend to settle into routines of activity throughout the course of the day. It is relatively straightforward to recognize overnight sleep and daytime nap periods as well as feeding time(s). Besides the positional information from the GPS receiver and the motion data from the accelerometer or other motion sensor, the collar unit also has GPS time which, when coupled with knowledge of the specific time zone, will allow assemblage of a database of normal daily activity. This information will improve reaction time and decision making in response to deviations from normal behavior.

### Habitual Behavior—Escape Routes and Times

An animal that frequently attempts to breach the containment perimeter will often use the same route during the attempt. This behavior is analogous to the behavior of animals that are contained by a physical fence, wherein they attempt to dig under the fence, typically at same location. The animal might also habitually chase the mailman, who arrives each day at a consistent time or the local deer herd that begins foraging at dusk. Therefore, any attempts to breach the perimeter are charted for time and location (independently) and used to predict such repetitive behaviors.

### New Pet

It is likely that, at some point, a new pet will be introduced into the monitored perimeter. The system employing the adaptive response protocol that is disclosed herein will quickly “learn” the new behavior patterns without action or intervention by the customer. “Old” patterns no longer repeated are “discarded” over time as the database is update with new behavioral data for the new pet. In some embodiments, the system can be reset to return it to a default fixed-rule-based mode of operation and allow it to “learn” the behavior of the new animal.

The learning function described above is based on any and all data collected from various sources and sensors. The following are some non-limiting examples of the type of data obtained and its use.
1. Significant accelerometer events tagged with their time of occurrence provide data, the analysis of which can reveal pattern behavior such as fence running without the. use of the GPS circuitry.
2. Stored waypoints from prior run-through occurrences matched with stored accelerometer data are used to detect an impending breach, to which the unit responds preemptively with a warning or correction.
3. GPS signal loss can be ignored for extended periods of time if the last fixed location was a known habituation point and little or no (non baseline) accelerometer data is detected.
4. In the event that significant motion is detected via GPS or accelerometer data, which coincides with historical activity at a coincident time of day then, based on that prior activity, system responds by either: (i) taking preemptive action, (ii) continuing to monitor behavior, or (iii) ignoring the behavior.

Power conservation is achieved via the use of the adaptive response protocol by:
reducing the update rate of the GPS subsystem (65 ma typical draw);
relying on the data from the accelerometer (0.6 ma typical draw) instead of the GPS subsystem.
   GPS signal attenuation and blocking caused by foliage or other obstructions is mitigated, to some extent, by the present adaptive response protocol coupled with motion sensing data.

It is to be understood that the above-described embodiments are merely illustrative of the present invention and that many variations of the above-described embodiments can be devised by those skilled in the art without departing from the scope of the invention. It is therefore intended that such variations be included within the scope of the following claims and their equivalents.

I claim:

1. A method comprising:
obtaining and storing way-points for said first period of time, wherein said way-points track a monitored animal's movements; and
developing a first correlation between a first repetitive behavior and a likelihood that said monitored animal will breach a containment perimeter, wherein said first repetitive behavior is evidenced by said stored way-points and said correlation is developed by analyzing said stored waypoints.

2. The method of claim 1 further comprising developing a set of rules, based on said first correlation, for determining a likelihood that said monitored animal will breach said containment perimeter.

3. The method of claim 1 further comprising taking action based on said set of rules, wherein said action is selected from the group consisting of issuing a warning to a monitored animal; issuing a correction to a monitored animal; continuing to monitor; and cease monitoring.

4. The method of claim 1 further comprising following an initial set of rules for a first period of time before developing said first correlation, wherein said initial set of rules comprise rules for determining a likelihood that a monitored animal will breach a perimeter.

5. The method of claim 4 further comprising:
developing a set of rules for determining a likelihood that said monitored animal will breach said containment perimeter, wherein said set of rules is developed by modifying said initial set of rules by said first correlation; and
following said set of rules after said first period of time.

6. The method of claim 1 wherein said likelihood that said monitored animal will breach said containment perimeter is used to determine a rate at which a locational fix of said monitored animal is obtained.

7. The method of claim 1 wherein said first repetitive behavior relates to a shape or pattern that is defined by a plurality of consecutively-obtained waypoints.

8. The method of claim 1 wherein said first repetitive behavior relates to the presence of said monitored animal at a specific location, as indicated by said way-points, at a certain time of day or time of the year.

9. The method of claim 1 wherein said first repetitive behavior relates to one of either the presence of said monitored animal at a specific location irrespective of time of day, as indicated by said way-points, or to a time of day.

10. The method of claim 2 further comprising developing a second correlation between a second repetitive behavior and a likelihood that said monitored animal will breach a containment perimeter, wherein said second repetitive behavior is evidenced by said stored way-points and said second correlation is developed by analyzing said stored waypoints.

11. The method of claim 10 wherein said set of rules is based on said second correlation as well as said first correlation.
